(19) United States
(12) Patent Application Publication
(10) Pub. No.: US 2004/0196376 A1
(43) Pub. Date: Oct. 7, 2004

(54) Still image generating apparatus and still image generating method

(76) Inventors: Tetsuya Hosoda, Nagano-ken (JP); Seiji Aiso, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/751,202

(22) Filed: Jan. 2, 2004

(30) Foreign Application Priority Data
Jan. 7, 2003 (JP) 2003-1124
Sep. 30, 2003 (JP) 2003-339894

(51) Int. Cl. H04N 5/262

(52) U.S. Cl. 348/207.1; 348/208.13; 348/239

(57) ABSTRACT

The still image generating apparatus of the present invention includes an image acquisition unit that obtains from among multiple image data multiple first image data that are arranged in a chronological fashion, an image storage unit that stores the multiple first image data obtained by the image acquisition unit, a correction amount estimation unit that estimates with regard to the multiple first image data stored in the image storage unit the amount of correction required to correct for positional deviation among the images that are expressed by the various items of image data, and an image synthesizer that corrects the positional deviation among the images expressed by the multiple first image data based on the estimated correction amounts, and synthesizes the corrected multiple first image data to generate as still image data second image data having a higher resolution than the first image data.

Using the construction described above enables the processing time required when image synthesis is performed using multiple image data to be reduced.

### BACKGROUND OF THE INVENTION

1. Field of the Invention

The present invention pertains to a technique of generating still image data having a relatively high resolution from multiple image data having a relatively low resolution.

2. Description of the Related Art

Moving image data that is captured and recorded by a digital video camera or the like contains multiple relatively low-resolution image data (such as frame image data and the like). In the conventional art, one frame image data is obtained from this moving image data and is used as a still image. When frame image data is obtained from moving image data, still image data having a higher resolution is generated by obtaining and combining multiple frame image data and performing image synthesis by interpolating the pixel data. The method by which the multiple frame image data are combined and synthesized in this fashion can be expected to result in higher image quality than a method in which one frame image undergoes resolution conversion. Here, ‘resolution’ refers to the density or number of pixels constituting one image.

As a technology to create the still image data described above, Japanese Patent Laid-Open No. H11-164264, for example, discloses a technology by which a high-resolution image is generated by selecting from among (n+1) continuous frame images a frame image as a reference frame image, calculating the movement vectors for the other (n) frame images (target frame images) relative to this reference frame image, and synthesizing the (n+1) frame images based on each of these movement vectors.

However, where a high-resolution image is created through synthesis of multiple low-resolution frame image data as described above, because the processing time is much longer than the time needed for creation of a high-resolution image via interpolation of image data from one frame image, demand exists in the art for a shortening of such processing time.

In addition, such demand exists not only where still images are obtained from moving image data as described above, but also where such images are obtained simply from multiple image data.

### SUMMARY OF THE INVENTION

Therefore, in view of the foregoing, an object of the present invention is to provide a technology that offers reduced processing time when image synthesis is performed using multiple image data.

In order to achieve at least a part of the above object, the still image generating apparatus of the present invention is a still image generating apparatus that generates still image data from multiple image data, comprising:

an image acquisition unit that obtains from among the multiple image data multiple first image data that are arranged in a time series;

an image storage unit that stores the multiple first image data obtained by the image acquisition unit;

a correction amount estimating unit that estimates with regard to the multiple first image data stored in the image storage unit the amount of correction required to correct for positional deviation among the images that are expressed by the multiple first image data; and

an image synthesizer that corrects the positional deviation among the images expressed by the multiple first image data based on the estimated correction amounts, and synthesizes the corrected multiple first image data to generate as the still image data second image data having a higher resolution than said first image data.

When second image data having a higher resolution than the first image data is generated as described above, because there is no longer any need to obtain once more from the multiple image data multiple first image data arranged in a time series, and second image data can be generated using the multiple first image data stored in the image storage unit, the time required for processing can be reduced accordingly.

The multiple image data described above may include moving image data. In this case, the still image data can be generated from moving image data.

A construction may be employed wherein the image acquisition unit obtains the multiple first image data from the multiple image data when an instruction for image data acquisition is issued, and the image storage unit stores the obtained multiple first image data.

For example, where the multiple image data constitute moving image data, and the file format of this moving image data is random access format as described below, the multiple first image data can be obtained directly from the moving image data. Therefore, the processing described above can be performed when an instruction for image acquisition is issued.

It is also acceptable if the image acquisition unit acquires the first image data in sequence from among the multiple image data, the image storage unit sequentially updates the stored multiple first image data using the obtained first image data, and the image storage unit maintains the stored multiple first image data when image data acquisition is instructed.

For example, where the multiple image data constitute moving image data, and the file format of this moving image data is sequential access format as described below, it is difficult to obtain the multiple first image data directly from the moving image data, but if the first image data is sequentially obtained from the moving image data and the multiple stored first image data are sequentially updated using the obtained first image data as described above, the multiple first image data can be easily acquired when an image acquisition instruction is issued by maintaining the stored multiple first image data.

The image storage unit may also save the second image data generated by the image synthesizer in addition to the multiple first image data.

In this case, the generated second image data can be read out and used at any time.

It is acceptable if, where one of several synthesis methods can be selectively chosen by the image synthesizer when the corrected multiple first image data are synthesized to generate the second image data, the image storage unit stores the second image data synthesized using different synthesis methods separately according to the synthesis method used.

In this case, the second image data synthesized using different synthesis methods can be read out and used as necessary.

It is furthermore acceptable if, where an instruction to re-synthesize the corrected multiple first image data using the same synthesis method that was previously employed is issued, the image synthesizer does not synthesize the corrected multiple first image data but rather reads out from the image storage unit the second image data that was previously synthesized using the same synthesis method described above.

In this case, because identical synthesis processing is not duplicated, processing time is reduced accordingly.

The image storage unit may also save, in addition to the multiple first image data, position information indicating the time location within the multiple image data of at least one of the multiple first image data obtained.

In this case, because the use of saved position information enables easy access to the time location within the multiple stored image data of at least one of the multiple first image data, the processing time required to acquire other image data located close to that position within the multiple image data can be reduced.

It is furthermore acceptable if the present invention includes a thumbnail image creating unit that creates thumbnail image data from the second image data generated by the image synthesizer and an image display unit that displays at least the thumbnail image expressed by this thumbnail data, and the image display unit displays the thumbnail data together with prescribed information concerning the second image data corresponding to the thumbnail image.

In this case, because the user can observe not only the thumbnail image corresponding to the generated second image data, but also information concerning the second image data together with the thumbnail image, the contents of the generated second image data can be comprehensively understood.

It is furthermore acceptable if, where the image synthesizer can selectively choose the synthesis method from among a number of such methods when synthesizing the corrected multiple first image data to generate second image data, the prescribed information described above is information that indicates the synthesis method employed when the second image data corresponding to the thumbnail image data was generated.

In this case, the user can easily learn which of the several synthesis methods was used simply from observing this information together with the thumbnail image.

The present invention is not limited to an apparatus such as the still image generating apparatus described above, and may be realized in the form of a method such as a still image generating method. The present invention may furthermore be realized as a computer program that implements such method or apparatus, as a recording medium on which this computer program is recorded, as data signals that are expressed in a carrier wave and incorporate this computer program, or in some other form.

Moreover, where the present invention is realized via a computer program or a recording medium on which such computer program is recorded, the program may constitute the entire program that controls the operations of the apparatus, or may constitute a program that implements only the functions of the present invention.

These and other objects, features, aspects, and advantages of the present invention will become more apparent from the following detailed description of the preferred embodiments with the accompanying drawings.

### BRIEF DESCRIPTION OF THE DRAWINGS

FIG. 1 shows the basic construction of the still image generating system 100 constituting one embodiment of the present invention;

FIG. 2 is a block diagram showing the functions of the CPU 11 and the RAM 13 of the still image generating system of the above embodiment;

FIG. 3 is a flow chart showing the sequence of operations performed during sequential access mode, which constitutes one of the processes executed in this embodiment;

FIG. 4 is a flow chart showing the sequence of operations performed during random access mode, which constitutes one of the processes executed in this embodiment;

FIG. 5 is a drawing showing the preview screen 200, which is displayed on the CRT 18a in this embodiment;

FIG. 6 is an explanatory drawing of the buffer 140 in this embodiment;

FIG. 7 is a drawing representing the situation wherein a thumbnail image 221 is generated when the user presses the frame image acquisition button 236 in this embodiment;

FIGS. 8(a) through (c) are explanatory drawings showing a data list in this embodiment;

FIG. 9 is a flow chart showing the still image generation process in this embodiment;

FIGS. 10(a) through (c) are explanatory drawings regarding the selection of the type of still image generating process in this embodiment;

FIG. 11 is a drawing representing the situation wherein a processing type number is entered in connection with a thumbnail image;

FIG. 12 is an explanatory drawing showing deviation between the frame image for the reference frame and the frame image for the target frame;

FIG. 13 is an explanatory drawing showing correction of the deviation between the target frame image and the reference frame image;

FIG. 14 is an explanatory drawing showing the closest pixel determination process of this embodiment;

FIG. 15 is an explanatory drawing that explains the image interpolation using the bilinear method in this embodiment;

FIG. 16 is a drawing representing the situation wherein a balloon is displayed with a thumbnail image; and

FIGS. 17(a) and 17(b) are explanatory drawings of the search process carried out using the absolute frame number in this embodiment.

### DESCRIPTION OF THE PREFERRED EMBODIMENTS

An embodiment of the present invention will be described below in accordance with the following sequence:

(1) Embodiment

A. Still image generating system construction

B. Summary of processes

B1. Overall sequence of processes

B1-1. Sequential access mode

B1-2. Random access mode

B1-3. Data list creation

B1-4. Still image generation

C. Still image data generation process

C1. Frame image data acquisition

C2. Correction amount estimation

C3. Synthesis

D. Results

(2) Variation

(1) Embodiment

A. Still Image Generating System Construction

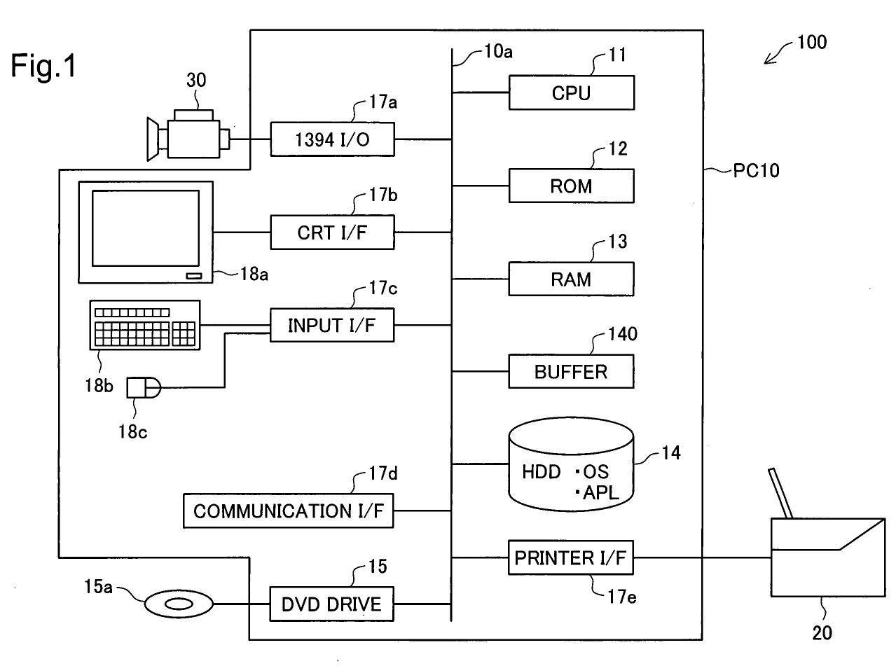

FIG. 1 shows the basic construction of the still image generating system 100 constituting one embodiment of the present invention. The system 100 is composed of a personal computer 10 (hereinafter termed ‘PC 10’), a digital video camera 30 that can output moving image data, and other components. The PC 10 functions as a still image generating apparatus that generates frame image data that expresses still images having a relatively higher resolution based on multiple relatively low-resolution frame image data contained in the moving image data.

In this embodiment, an image expressed by frame image data is also called a frame image. The term ‘frame image’ refers to a still image that can be displayed using the non-interlace method. In addition, the relatively high-resolution still image data generated via synthesis of multiple frame images is termed generated still image data, and the image expressed by this generated still image data is termed a generated still image.

The PC 10 includes a CPU 11 that executes calculation processes, a ROM 12, a RAM 13, a DVD-ROM drive 15 (hereinafter termed ‘DVD drive 15’), an 1394 I/O 17a, various interfaces (I/F) 17b through 17e, an HDD (hard disk) 14, a CRT 18a, a keyboard 18b and a mouse 18c.

Stored on the HDD 14 are the operating system (OS), application programs (APL, including the Application X described below) that can create still image data and the like, and other programs. During program execution, the CPU 11 forwards the software to the RAM 13 as necessary, and executes the program while accessing the RAM 13 as a temporary work area. The HDD 14 includes at least a drive area C (hereinafter ‘C drive’), a folder or file storage area under the C drive, and a file storage area under the folder area.

The 1394 I/O 17a is an I/O port that complies with the IEEE 1394 standard, and is used to connect to such devices as a video camera 30 that can generate and output moving image data.

The display 18a capable of displaying frame images is connected to the CRT 17b, and the keyboard 18b and mouse 18c are connected to the input I/F 17c as input devices to enable operation of the apparatus.

A printer 20 is connected to the printer I/F 17e via a parallel I/F cable. Naturally, the printer 20 may be connected using a USB cable or the like.

A DVD-ROM 15a on which moving image data is recorded is inserted in the DVD-ROM drive 15, such that moving image data may be read out therefrom.

The buffer 140 includes buffer areas 301 through 304 that can temporarily store frame image data. The RAM 13 includes a data list storage area 115 used for storage of the data list described below.

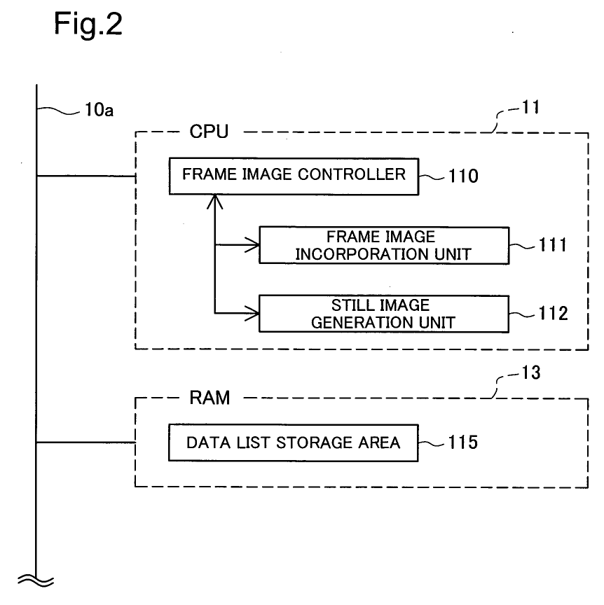

As shown in FIG. 1, the CPU 11 is connected to each component via the system bus 10a through execution of the Application X, and performs overall control of the PC 10. FIG. 2 is a block diagram showing the functions of the CPU 11 and the RAM 13 in the still image generating system of this embodiment. When the process to generate a generated still image is executed, the CPU 11 functions as a frame image controller 110, a frame image acquisition unit 111 and a still image generating unit 112. The frame image controller 110 controls the various components and performs overall control of the processing to generate a generated still image. For example, when an instruction to play moving images is input by the user via the keyboard 18b or the mouse 18c, the frame image controller 110 reads into the RAM 13 moving image data from the DVD-ROM 15a loaded in the DVD drive 15 or a digital video tape (not shown) constituting a recording medium for the digital video camera 30. The frame image controller 110 sequentially displays on the CRT 18a via the video driver multiple frame images contained in the read-in moving image data. As a result, moving images are displayed on the CRT 18a. The frame image controller 110 also controls the operations of the frame image acquisition unit 111 and still image generation unit 112 to generate still image data from frame image data for multiple frames. The CPU 11 also controls the printing of generated still image data by the printer 20.

The BIOS that runs the hardware described above, as well as the OS and APLs that reside on top of the BIOS, are executed by the PC 10. Various types of drivers, such as the printer driver that controls the printer I/F 17e, are loaded in the OS and control the hardware. The printer driver can perform bidirectional communication to and from the printer 20 via the printer I/F 17e, receive image data from APLs, create a print job, and send the resulting print job to the printer 20.

As described above, the still image generating apparatus is implemented by both the hardware and software in combination.

B. Summary of Processes

B-1. Overall Sequence of Processes

In this embodiment, the Application X can execute various processes such as the still image generation process described below. When the user boots the Application X, the user interface screen (not shown) that enables the user to select whether the format of the moving image file to be played is sequential access format or random access format is displayed on the CRT 18a. The frame image controller 110 performs mode switch control based on the moving image file format specified by the user.

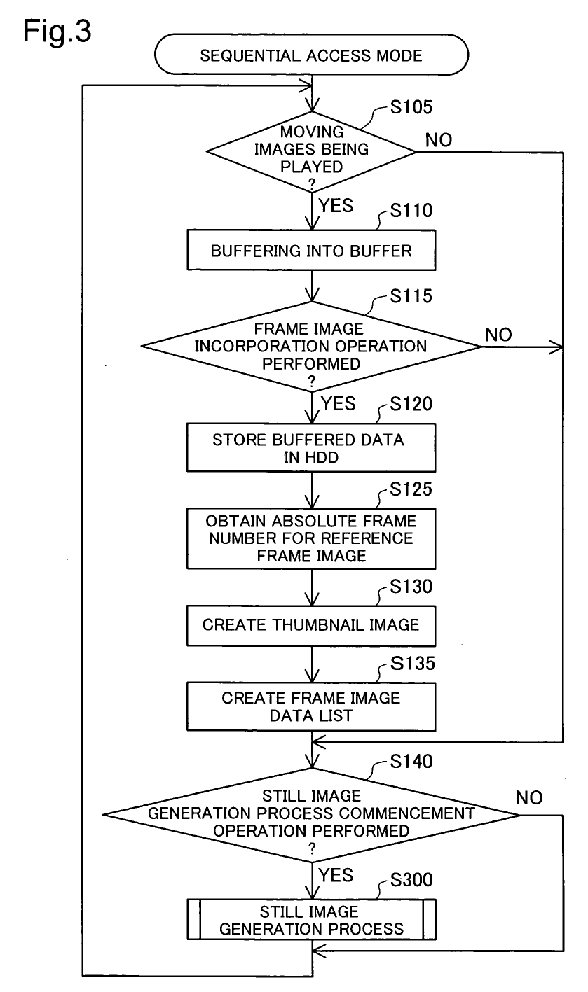

Sequential access format is a format in which multiple recorded data are accessed according to a fixed sequence. This format is the format used when moving image data recorded on a digital video tape is accessed, for example. Where the user-specified moving image file format is sequential access format, the frame image controller 110 switches to sequential access mode and executes the sequential access mode process shown in FIG. 3. FIG. 3 is a flow chart showing the sequence of operations of the sequential access mode process constituting one process executed in this embodiment. When this process is executed, the frame image controller 110 performs control to enable access to the digital video camera 30, which uses a digital video tape (not shown) as the recording medium. The sequential access mode process is explained in detail below.

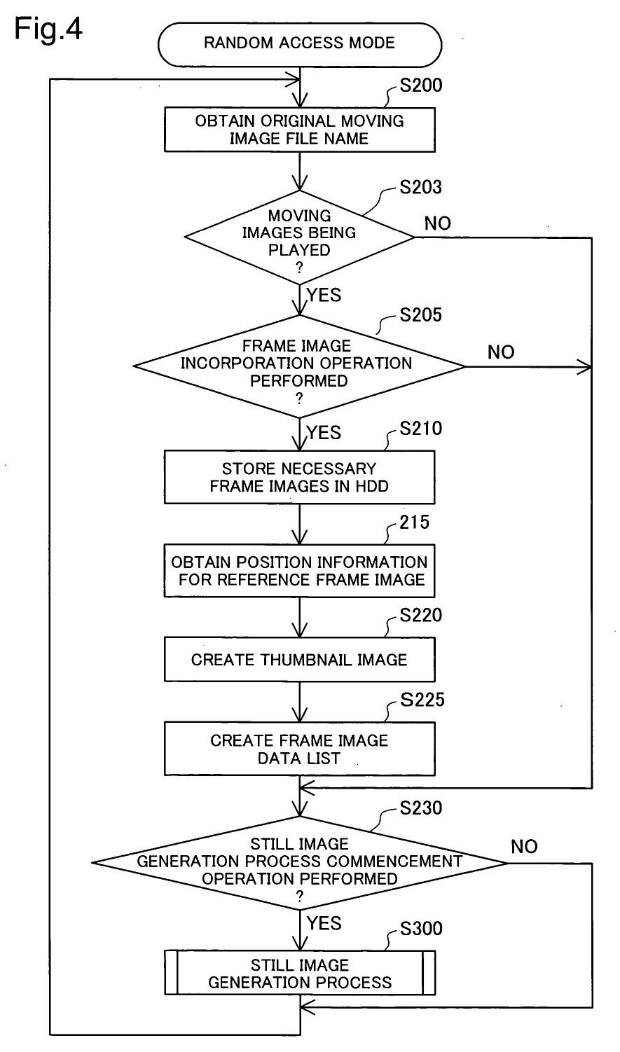

Random access format is a format in which any desired data record is accessed by specifying the position of that data record. This format is the format used when moving image data recorded on a DVD-ROM 15a is accessed, for example. Where the user-specified moving image file format is random access format, the frame image controller 110 switches to random access mode and executes the random access mode process shown in FIG. 4. FIG. 4 is a flow chart showing the sequence of operations of the random access mode process constituting one process of this embodiment. When this process is executed, the frame image controller 110 performs control to enable access to the DVD drive 15 in which the DVD-ROM 15a is loaded. The random access mode process is explained in detail below.

The Application X in this embodiment can interrupt the sequential access mode process during mid-processing and switch to the random access mode process. It can also interrupt the random access mode process even during mid-processing and switch to the sequential access mode process. Furthermore, the Application X can be terminated when necessary even when the sequential access mode or the random access mode is active. In any of these situations, the frame image controller 110 performs control based on user instructions to interrupt the current mode, switch among modes, or end the Application X.

B1-1. Sequential Acess Mode

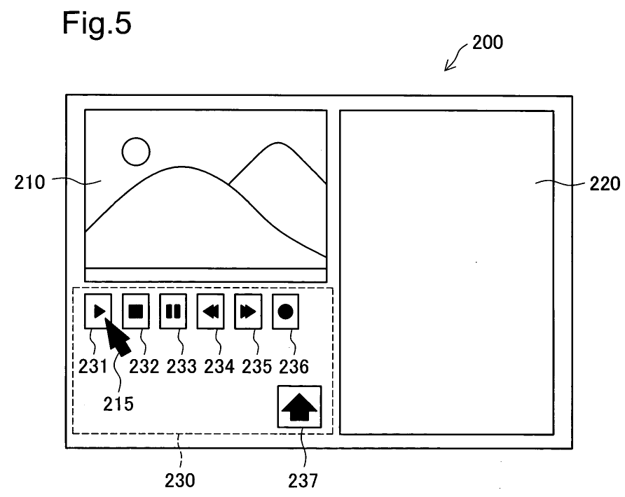

Before the sequential access mode process shown in FIG. 3 is explained, the preview screen 200 displayed on the CRT 18a will be explained. FIG. 5 is a drawing showing the preview screen 200 displayed on the CRT 18a in this embodiment. The preview screen 200 shown in FIG. 5 is divided into three areas: a preview area 210, a thumbnail image display area 220 and a user instruction area 230. The preview area 210 is a display area that plays moving images or displays a frame image as a still image when it is specified from among the moving images. The thumbnail image display area 220 is an area that displays thumbnail images 221 described below and the like. The user instruction area 230 contains seven buttons: a play button 231, a stop button 232, a pause button 233, a rewind button 234, a fast forward button 235, a frame image acquisition button 236 and a still image generation button 237. Pressing the play button 231, stop button 232, pause button 233, rewind button 234 or fast forward button 235 enables the moving images in the preview area 210 to be played, stopped, paused, rewound or fast forwarded. For example, if the user presses the play button 231 by moving and operating the mouse cursor 215 using the mouse 18c or the keyboard 18d, the frame image controller 110 reads out moving image data from the video camera 30 and plays the moving images in the preview area 210 by displaying the moving image data as moving images in the preview area 210. The frame image acquisition button 236 and the still image generation button 237 will be explained in detail below.

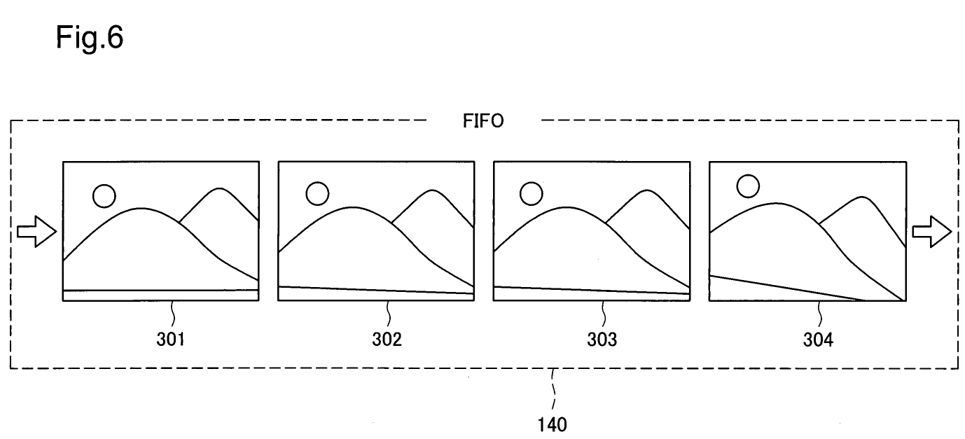

First, when the sequential access mode process shown in FIG. 3 is executed, the frame image controller 110 first determines whether or not moving images are being played in the preview area 210 (step S105). If moving images are being played (YES in step S105), the frame images being played are buffered in the sequential buffer 140 (step S110). ‘Buffering’ here means the temporary storage of frame image data. This buffering will be described below with reference to FIG. 6. FIG. 6 is an explanatory drawing of the buffer 14 used for buffering of the frame image data from the moving image data in this embodiment. As shown in FIG. 6, the buffer 140 contains four buffer areas 301 through 304, and each buffer area is used for buffering of the data for one frame image. The frame image data identical to the frame image data for the frame image played in the preview area 110 is buffered in the buffer area 210 by the frame image controller 110. The frame image data buffered in the buffer area 301 prior to this buffering is shifted to the buffer area 302 and buffered therein. Similarly, the frame image data buffered in the buffer area 302 is shifted to the buffer area 303 and buffered therein, and the frame image data buffered in the buffer area 303 is shifted to the buffer area 304 and buffered therein. The frame image data buffered in the buffer area 304 is discarded. In this way, the frame image data is buffered in the buffer areas 301 through 304 in time-series order. This buffering method is called the FIFO (or tunnel stack) method. The frame image data buffered in the buffer area 301 is identical to the frame image data for the frame image being played in the preview area 210, as described above, and constitutes the frame image data that serves as the reference when multiple frame image data are combined in the synthesizing process to generate generated still image data as described below. Therefore, it is hereinafter referred to as ‘reference frame image data’.

If moving image data is not being played (NO in step S105), the CPU 11 advances to the operation of step S140.

The frame image acquisition unit 111 then determines whether or not a frame image acquisition operation has been executed (step S115). When the mouse cursor 215 is moved and operated by the user so as to press the frame image acquisition button 236, the frame image acquisition unit 111 determines that the frame image acquisition operation has been performed (YES in step S115) and incorporates into the work area of the RAM 13 the four frame image data buffered in the buffer areas 301 through 304 of the buffer 140 for temporary storage. Where the frame image acquisition unit 111 determines that the frame image acquisition operation has not been executed (NO in step S115), it advances to the operation of step S140.

The frame image controller 110 records the four frame image data that were temporarily saved in the work area of the RAM 13 in a prescribed area of the HDD 14 and attaches file names thereto (step S120). In addition, among the four frame image data temporarily saved in the RAM 13, the frame image controller 110 obtains the absolute frame number for the reference frame image data buffered in the buffer area 301 by accessing the digital video camera 30 (step S125). For example, header information indicating the absolute frame number is attached to each frame image data belonging to the moving image data stored on the digital video tape, and the frame image controller 110 may access the digital video camera 30 and obtain the absolute frame number for the buffered frame image data as it buffers the frame image data from the moving image data in the buffer area 301, as described above. The absolute frame number is a sequential number obtained by counting sequentially from the first frame of the digital video tape (not shown) constituting a recording medium for the digital video camera 30 in this embodiment.

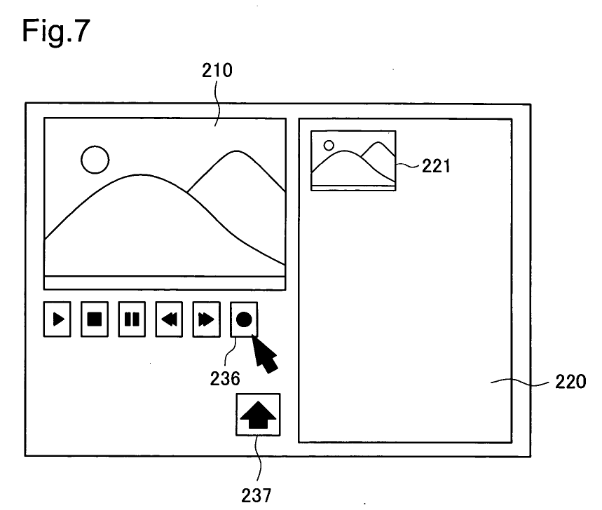

Next, the frame image controller 110 uses the reference frame image data from among the four frame image data temporarily saved in the work area of the RAM 13 to create thumbnail image data in the form of a bitmap having an 80×60 resolution, and displays a thumbnail image 221 in the thumbnail image display area 220, as shown in FIG. 7 (step S130). FIG. 7 shows a situation wherein a thumbnail image 221 has been generated following the pressing of the frame image acquisition button 236 by the user.

The frame image controller 110 then creates a data list used to manage various information pertaining to the obtained four frame image data, such as the thumbnail image data created in the operation of step S130 (step S135 in FIG. 3). The frame image controller 110 saves the created data list in the data list storage area 115.

The data list created in this operation will be explained in detail below.

When creation of the data list is completed, the frame image controller 110 determines whether or not the operation to commence the still image generation process has been performed (step S140). When the user moves and operates the mouse cursor 215 to specify a thumbnail image displayed in the thumbnail image display area 220 for which to generate a still image and presses the still image generation button 237, the frame image controller 110 determines that the operation to commence the still image generation process has been performed (YES in step S140) and causes the still image generation unit 112 to execute the still image generation process (step S300).

This still image generation process will be explained below.

If the frame image controller 110 determines that the operation to commence the still image process was not performed (NO in step S140), it returns to the operation of step S105 and repeats the processing described above.

B2-2. Random Access Mode

If the random access mode process shown in FIG. 4 is executed, on the other hand, first, the frame image controller 110 obtains the original moving image file name for the moving images being displayed in the preview area 210 and saves the image data in the RAM 13 after attaching the file name (step S200). Specifically, the frame image controller 110 accesses the DVD drive 15 and obtains the original moving image file name from the inserted DVD-ROM 15a.

Next, the frame image controller 110 determines whether or not moving images are playing in the preview area 210 (step S203). If moving images are being played (YES in step S203), the frame image acquisition unit 111 determines whether or not the frame image acquisition operation has been performed (step S205). Specifically, if the user moves and operates the mouse cursor 215 to press the frame image acquisition button 236, the frame image acquisition unit 111 determines that the frame image acquisition operation has been performed (YES in step S205). Here, the frame image acquisition unit 111 obtains the frame image data identical to the frame image data represented by the frame image being displayed in the preview area 210 and the three time-series frame image data for frame images displayed in the preview area 210 immediately before this frame image from the DVD-ROM 15a inserted in the DVD drive 15, and temporarily stores the four frame image data in the work area of the RAM 13. Because among the temporarily saved frame image data the frame image data identical to the frame image data for the frame image being displayed in the preview area 210 is the frame image data constituting the reference where multiple frame image data are combined in the synthesis process for generation of a still image described below, it will hereinafter be termed the ‘reference frame image data’. If moving images are not being played (NO in step S203), the frame image controller 110 advances to the processing of step S230 described below.

The frame image controller 110 then stores the four frame image data temporarily saved in the work area of the RAM 13 in a prescribed area of the HDD 14 and attaches file names thereto (step 210).

The frame image controller 110 next accesses the DVD drive 15 and obtains the position information for the reference frame image data (step S215). For example, header information indicating the position information is attached to each frame data belonging to the moving image data recorded on the DVD-ROM 15a, and the frame image controller 110 obtains frame image data from the moving image data as well as the position information for the obtained frame image data from this header information by accessing the DVD drive 15. This position information may constitute either an absolute frame image number located on the DVD-ROM 15a or a number indicating the ordinal position of the frame image in one moving image data located on the DVD-ROM 15a.

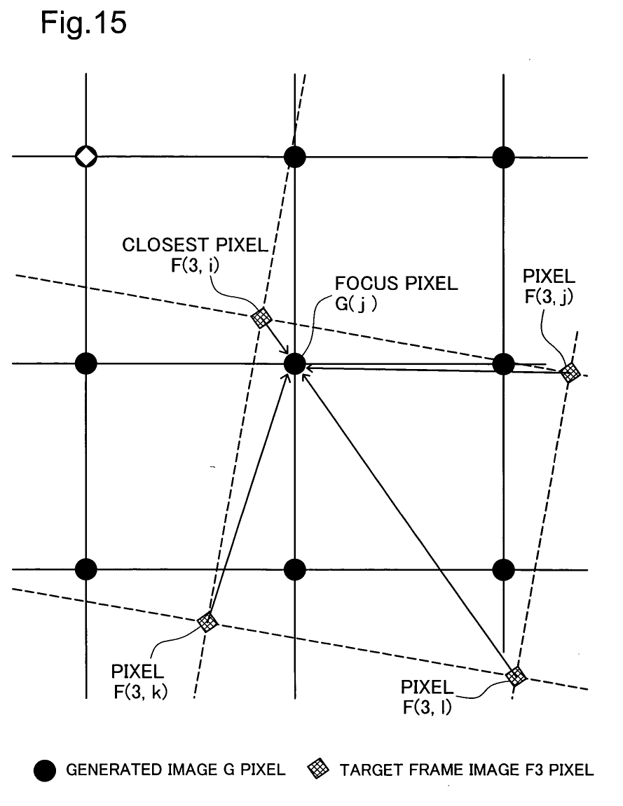

When the position information has been obtained, the reference frame image data is used to create data for a thumbnail image in the form of a bitmap image having an 80×60 resolution, and a thumbnail image 221 is displayed in the thumbnail image display area 220 as shown in FIG. 15 (step S220).

When thumbnail image creation has been completed, the frame image controller 110 creates a data list in which various information regarding the four obtained frame image data are entered, such as the thumbnail image data created in the operation of step S220 (step S225). The frame image controller 110 saves the created data list in the data list storage area 115.

The data list created via this operation will be explained in detail below.

When data list creation has been completed, the frame image controller 110 determines whether or not the operation to commence the still image generation process has been performed (step S230). When the user moves and operates the mouse cursor 215 to specify a thumbnail image within the thumbnail image display area 220 for which to generate a still image and presses the still image generation button 237, the frame image controller 110 determines that the operation to commence the still image generation process has been performed (YES in step S230) and causes the still image generation unit 112 to execute the still image generation process (step S300).

When the still image generation process (step S300) is completed, the frame image controller 110 returns to step S200 and repeats the processing described above. If the frame image controller 110 determines that the operation to commence the still image generation process was not performed (NO in step 230), it returns to the operation of step S200 and repeats the processing described above.

The still image generation process (step S300) will be described below.

B1-3. Data List Creation

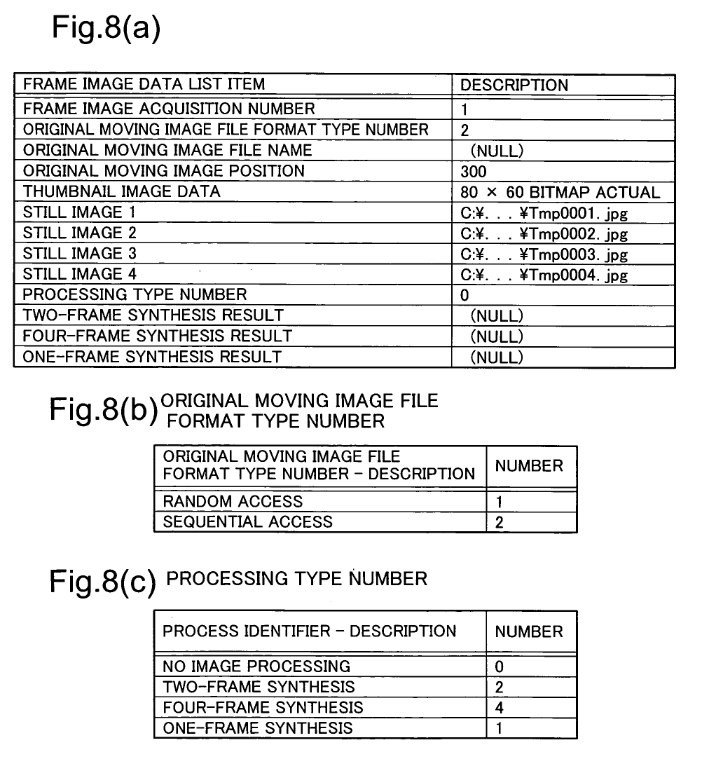

Here, creation of the data list created in step 135 in sequential access mode described above (FIG. 3) and in S220 in random access mode described above (FIG. 4) will be explained with reference to FIG. 8. FIGS. 8(a) through (c) are drawings to explain the data list. FIG. 8(a) is a data list, FIG. 8(b) is a drawing to explain the content associated with the original image file format type number, and FIG. 8(c) is a drawing to explain the content associated with the processing type number. In FIG. 8(a), the left half of the data list indicates the type of data list item, while the right half describes the content associated with that type of data list item.

For the ‘frame image acquisition number’, the sequential number indicating the number of times the frame image acquisition operation (YES in step S115 in the sequential access mode process (FIG. 3) and YES in step S205 in the random access mode process (FIG. 4)) was performed is entered. In FIG. 8, for example, ‘1’ is entered, indicating the first frame image acquisition operation.

For the ‘original moving image file format type number’, if the original moving image file format constituting the target of the above frame image acquisition operation is random access format, ‘1’ is entered, while if the original moving image file format is sequential access format, ‘2’ is entered, as shown in FIG. 8(b). In FIG. 8, ‘2’ is entered, indicating sequential access format.

For the ‘original moving image file name’, only when the original moving image file format is random access format, the file name of the original moving image file obtained via the operation of step S200 in the random access mode process (FIG. 4) is entered together with the storage path. In FIG. 8, because the format is sequential access format, nothing is entered, and the status is NULL.

For the ‘original moving image position’, where the original moving image file format is sequential access format, the absolute frame number of the reference frame image obtained in the operation of step S125 in the sequential access mode process (FIG. 3) is entered, and where the original moving image file format is random access format, the position information for the reference frame image obtained in the operation of step S215 in the random access mode process (FIG. 4) is entered. In FIG. 8, ‘300’ is entered, for example.

For the ‘thumbnail image’, where the original moving image file format is sequential access format, the actual data for the thumbnail image created in the operation of step S130 in the sequential access mode process (FIG. 3) is entered, and where the original moving image file format is random access format, the actual data for the thumbnail image obtained in the operation of step S220 in the random access mode process (FIG. 4) is entered.

For ‘still image 1’ through ‘still image 4’, the storage paths and file names associated with the four frame image data stored in the prescribed area of the HDD 14 are entered. Attached to each file name is a sequential number.

Specifically, where the original moving image file format is sequential access format, among the frame image data stored on the HDD 14 in the operation of step S120 in the sequential access mode process (FIG. 3), the storage path and file name associated with the frame image data that was buffered in the buffer area 301 in the operation of step S110 (i.e., the reference frame image data) is entered as the still image 1. Similarly, the storage paths and file names associated with the frame image data buffered in the buffer areas 302 through 304 are entered as the still images 2 through 4.

Where the original moving image file format is random access format, on the other hand, the storage path and file name associated with the frame image data indicating the frame image displayed in the preview area 210 and stored on the HDD 14 in the operation of step S210 in the random access mode process (i.e., the reference frame image data) are entered as the still image 1, and the storage paths and file names associated with the three time-series frame image data displayed in the preview area immediately before the reference frame image data was displayed in the preview area 210 are entered as the still images 2 through 4.

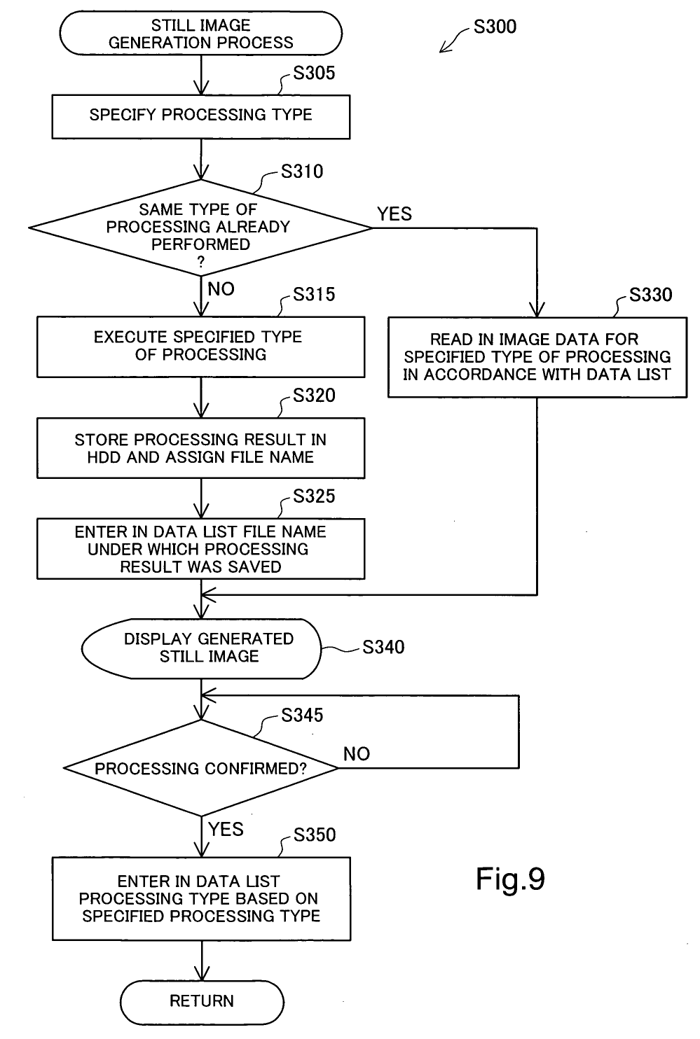

The ‘processing type number’ will be explained in connection with the operation of step S350 of the still image generation process described below (FIG. 9).

The data list items ‘result of two-frame synthesis’, ‘result of four-frame synthesis’ and ‘result of one-frame synthesis’ will be explained in connection with the operation of step S325 of the still image generation process described below (FIG. 9).

B1-4. Still Image Generation

FIG. 9 is a flow chart showing the still image generation process in this embodiment. The still image generation process (step S300) will be explained below with reference to FIG. 9.

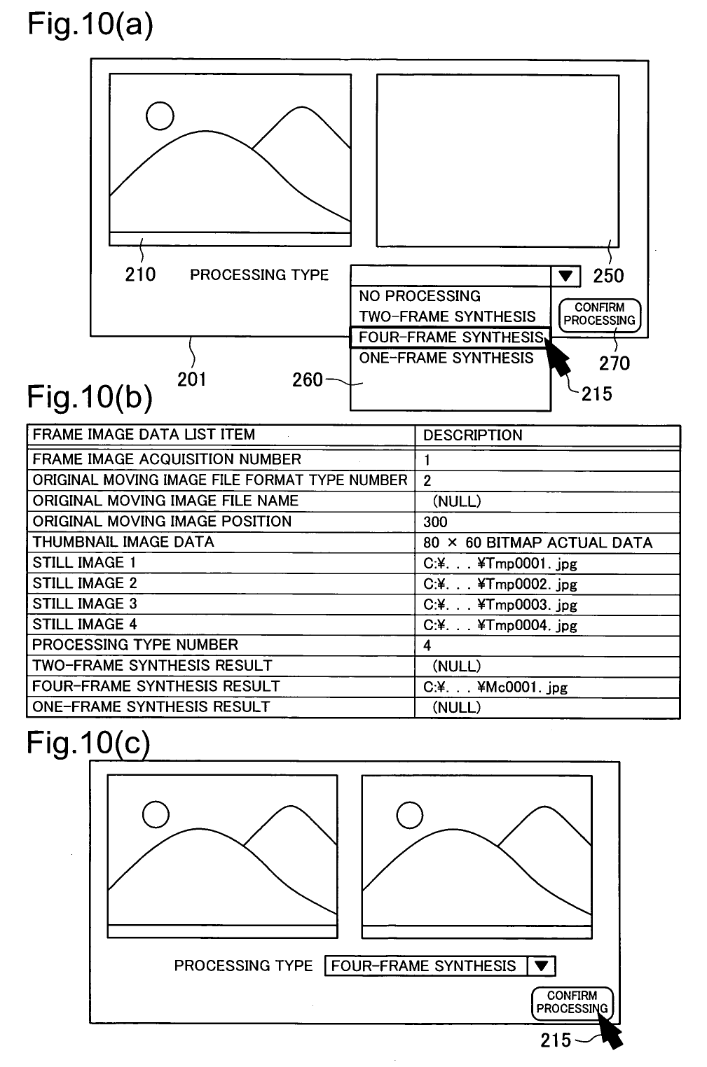

When the user specifies a thumbnail image within the thumbnail image display area 220 and presses the still image generation button 237, the frame image controller 110 determines that the operation to commence the still image generation process has been performed (YES in step S230 in FIG. 4), causes the still image generation processing type window 201 shown in FIG. 10(a) to appear, and displays it in the preview screen 200 in an overlapping fashion.

FIGS. 10(a) through (c) are explanatory drawings showing the selection of the type of still image generation processing in this embodiment. FIG. 10(a) shows the still image generation processing window 201, while FIG. 10(b) shows a sample data list in which the storage paths and file names of still image data have been entered. FIG. 10(c) shows a situation wherein a generated still image is being displayed in the still image generation processing window 201. As shown in FIG. 10(a), the preview area 210 described above is displayed at the left side of the still image generation processing window 201, the generated still image display area 250 in which the generated still image is displayed following still image generation is displayed at the right side of the still image generation processing window 201, the processing type pull-down list 260 from which the user can select a type of processing is displayed below these two preview areas, and the processing confirmation button 270 is displayed at the bottom right of the still image generation processing window 201.

The user can select a type of synthesis processing from the processing type pull-down list 260 (step S305 in FIG. 9). In this embodiment, four time-series frame image data were acquired in step S120 in the sequential access mode process (FIG. 3) or in step S210 in the random access mode process (FIG. 4). The process in which synthesis is performed using all four of these frame image data and one high-resolution still image data is generated is termed ‘four-frame synthesis’, the process in which synthesis is performed using two frame image data (including the reference frame image data) and one high-resolution still image data is generated is termed ‘two-frame synthesis’, and the process in which correction is performed based only on one frame image data (the reference frame image data) and one still image data is generated is termed ‘one-frame synthesis’.

The processing involved in ‘four-frame synthesis’ will be explained in detail below.

When the user specifies a type of processing from among the above types of synthesis processing, the frame image controller 110 reads out from the data list storage area 130 the data list in which the user-specified thumbnail image is stored, and determines in accordance with this data list whether or not the user-specified type of processing has already been performed (step S310). Here, if the user-specified type of processing is ‘two-frame synthesis’, the determination as to whether or not such processing has already been performed is made based on whether or not a path and file name exist in the ‘two-frame synthesis result’ field. Similarly, if the user-specified type of processing is ‘four-frame synthesis’, determination as to whether or not such processing has already been performed is made based on whether or not a path and file name exist in the ‘four-frame synthesis result’ field, and if the user-specified type of processing is ‘one-frame synthesis’, determination as to whether or not such processing has already been performed is made based on whether or not a path and file name exist in the ‘one-frame synthesis result’ field. Specifically, if a path and file name so exist, it is determined that the user-specified type of processing was already performed (YES in step S310), while if no path or file name exist, it is determined that the user-specified type of processing has not yet been performed (NO in step S310).

If the user-specified type of processing has not yet been performed (NO in step S310), the frame image controller 110 executes the specified type of processing (step S315) and stores the generated still image data in a prescribed area of the HDD 14 and assigns a file name thereto (step S320). The frame image controller 110 then enters the assigned storage path and file name in the corresponding data list field for ‘two-frame synthesis result’, ‘four-frame synthesis result’ or ‘one-frame synthesis result’ in accordance with the type of processing specified by the user (step S325). For example, if the user specifies ‘four-frame synthesis’, the frame image controller 110 reads out the appropriate data based on the paths and file names entered for still images 1 through 4 in the data list and performs the four-frame synthesis process described above using these data. The frame image controller 110 then stores the generated still image data generated from the ‘four-frame synthesis’ process in a prescribed area on the HDD 14 together with an assigned file name, and enters the storage path and assigned file name for the generated still image data in the ‘four-frame synthesis result’ data list field, as shown in FIG. 10(b).

The frame image controller 110 then displays the generated still image generated in the operation of step S315 in the generated still image display area 250 (step S340), as shown in FIG. 10(c).

Where the user-specified type of processing has already been performed (YES in step S310), the frame image controller 110 reads out from the HDD 14 the generated still image data that was previously generated via the specified type of processing based on the data list in which the user-specified thumbnail image is stored (step S330). For example, where the user-specified processing type is ‘four-frame synthesis’ and that processing has already been performed, a path and file name already exist in the ‘four-frame synthesis result’ field of the data list in which the user-specified thumbnail image is stored. Therefore, the frame image controller 110 reads out the frame image data associated with that path and file name from the HDD 14. The frame image controller 110 displays this generated still image in the generated still image display area 250 (step S340).

The frame image controller 110 then determines whether or not processing has been confirmed by the user (step S345). Specifically, when the processing confirmation button 270 is pressed, the frame image controller 110 determines that processing was confirmed (YES in step S345) and enters into the processing type number field in the data list the number corresponding to the user-specified processing type (step S305) as shown in FIG. 8(c) (step S350). For example, where the user-specified processing type is ‘two-frame synthesis’, ‘2’ is entered as the processing type number, where the user-specified processing type is ‘four-frame synthesis’, ‘4’ is entered as the processing type number, and where the user-specified processing type is ‘one-frame synthesis’, ‘1’ is entered as the processing type number. In the case of ‘no processing’, ‘0’ is entered.

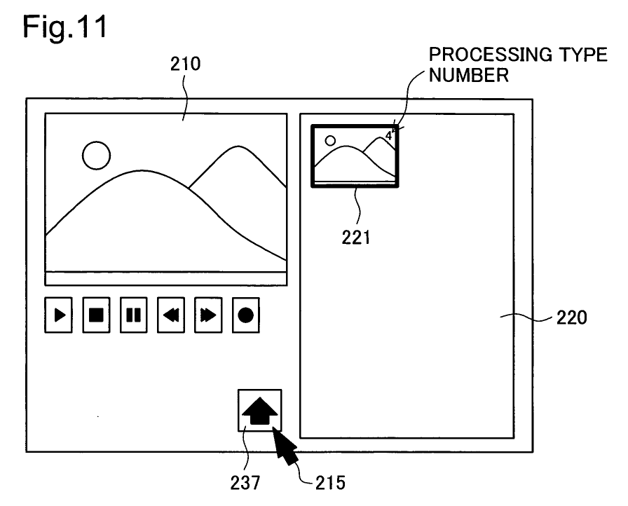

When processing is confirmed, the still image generation processing window 201 is closed and the preview screen 200 is displayed. Here, the frame image controller 110 displays the processing type number entered during the operation of step S350 in the thumbnail image 221 for which still image generation processing (step S300) was performed. For example, where the processing number specified in step S305 was ‘four-frame synthesis’, the number ‘4’ representing the processing type number for ‘four-frame synthesis’ is displayed in the thumbnail image 221, as shown in FIG. 11. Similarly, where the user-specified processing type was ‘two-frame synthesis’, the number ‘2’ representing the processing type number for ‘two-frame synthesis’ is displayed in the thumbnail image 221, and where the user-specified processing type was ‘one-frame synthesis’, the number ‘1’ representing the processing type number for ‘one-frame synthesis’ is displayed in the thumbnail image 221. In this way, the user can learn the last type of processing performed simply by looking at the thumbnail image. Where the processing confirmation button 270 is not pressed within a prescribed period of time (NO in step S345), the frame image controller 110 closes the still image generation processing window 201 and ends the still image generation process (step S300).

C. Still Image Data Generation Process

The process for generating one relatively high-resolution still image data via the ‘four-frame synthesis’ processing during the still image generation process described above (step S300) will be explained below.

C1. Frame Image Data Acquisition

Where ‘four-frame synthesis’ is to be performed in step S315 of the still image generation process described above (FIG. 9), the frame image controller 110 performs four-frame synthesis by loading into the RAM 13 from the HDD 14 as the four frame image data the frame image data associated with the paths and file names in the ‘still image 1’ through ‘still image 4’ fields of the data list.

The frame image data constitutes the gradation data for each pixel based on a dot-matrix system (hereinafter ‘pixel data’). The pixel data is either YCbCr data composed of Y (brilliance), Cb (blue chrominance difference) and Cr (red chrominance difference), or RGB data composed of R (red), G (green) and B (blue).

When four-frame synthesis is begun, first, the still image generation unit 112 estimates, under the control of the frame image controller 110, the amount of correction needed to correct the ‘deviation’ between the four frame images described above. The term ‘deviation’ here is caused not by the movement of the exposure subjects themselves, but rather by changes in the orientation of the camera such as so-called ‘panning’, or by hand shake. In this embodiment, deviation between frame images shifting an equal amount for all pixels is assumed. For purposes of estimating the correction amount, one of the four frame images is selected as a reference frame image, and the other three are deemed target frame images. For each target frame image, the correction amount required to correct for deviation from the reference frame image is estimated. In this embodiment, the image that represents the frame image data among the four frame image data read out as described above that corresponds to the path and file name in the ‘still image 1’ field of the data list is deemed the reference frame image. The images that represent the frame image data among the four frame image data read out as described above that correspond to the paths and file names in the ‘still image 2’ through ‘still image 4’ fields of the data list are deemed the target frame images.

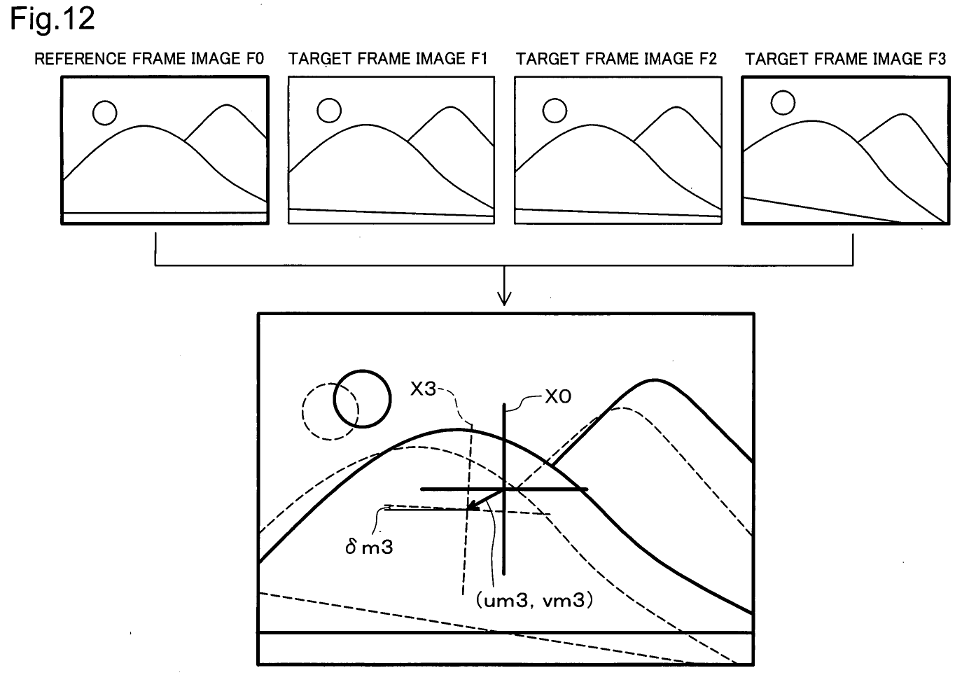

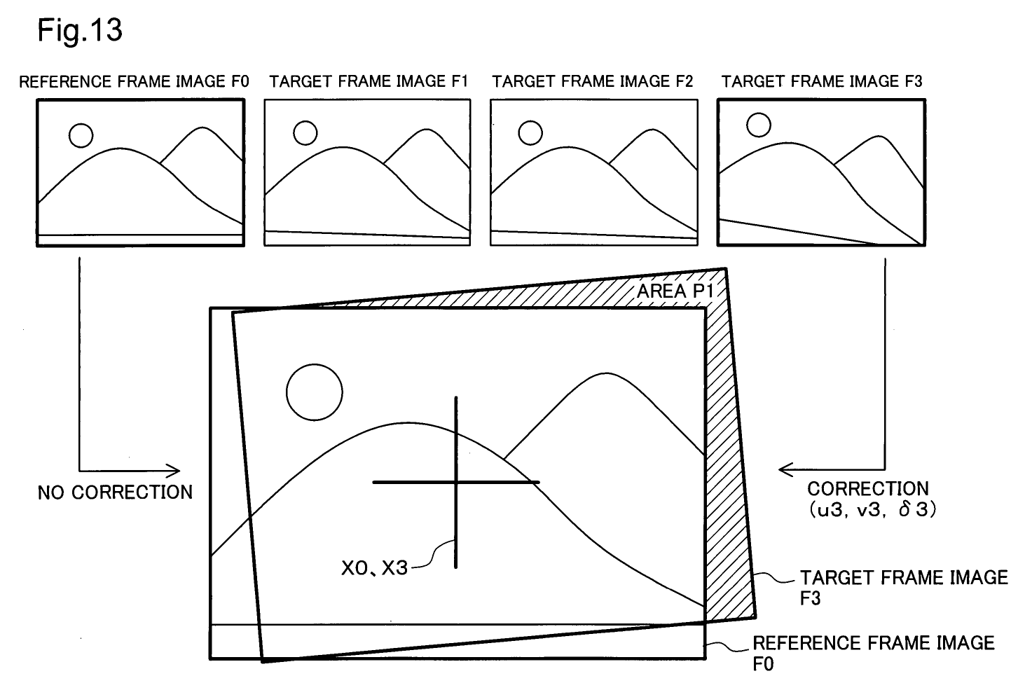

The still image generation unit 112 then corrects and synthesizes the four read-out frame image data using the sought correction amounts and generates still image data from the multiple frame image data. The correction amount estimation process and the synthesis process will be explained below with reference to FIGS. 12 and 13.

C2. Correction Amount Estimation

FIG. 12 is an explanatory drawing showing the deviation between the reference frame image and the target frame images. FIG. 13 is an explanatory drawing showing the correction of the deviation between the reference frame image and the target frame images.

In the explanation below, the symbols F0, F1, F2 and F3 are assigned to the four read-out frame images, and are respectively referred to as frame image F0, frame image F1, frame image F2 and frame image F3. Here, the frame image F0 is also referred to as the reference frame image and the frame images F1 through F3 are also referred to as the target frame images.

In FIGS. 12 and 13, the target frame image F3 is used as a representative of the target frame images F1 through F3, and deviation and deviation correction are explained with reference to this target frame image and the reference frame image F0.

Image deviation is expressed as a combination of translational (horizontal or vertical) deviation and rotational deviation. In FIG. 12, in order to make the deviation between the target frame image F3 and the reference frame image F0 easy to understand, the sides of the reference frame image F0 and the sides of the target frame image F3 are overlapped onto one another, a hypothetical cross X0 is placed at the center position of the reference frame image F0 and a cross X3 is placed at the equivalent location on the target frame image F3 to indicate the deviation between the reference frame image F0 and the target frame image F3. Furthermore, to make this deviation amount easy to understand, the reference frame image F0 and cross X0 are shown in boldface, while the target frame image F3 and cross X3 are shown using dashed lines.

In this embodiment, the translational deviation amount in the horizontal direction is expressed as ‘um’, the vertical translational deviation is expressed as ‘vm’, the rotational deviation is expressed as ‘δm’, and the deviation amounts for the target frame image Fa (where ‘a’ is an integer from 1 to 3) are expressed as ‘uma’, ‘vma’ and ‘δma’, respectively. For example, as shown in FIG. 12, the target frame image F3 has both translational and rotational deviation relative to the reference frame image F0, and these deviation amounts are expressed as ‘um3’, ‘vm3’ and ‘δm3’.

Here, in order to synthesize the target frame images F1 through F3 with the reference frame image F0, the position of each pixel in the target frame images F1 through F3 must be corrected so as to eliminate any deviation between the target frame images F1 through F3 and the reference frame image F0. The translational correction amounts used for this correction are expressed as ‘u’ in the horizontal direction and ‘v’ in the vertical direction, and the rotational correction amount is expressed as ‘δ’. If the correction amounts for the target frame image Fa (where ‘a’ is an integer from 1 to 3) are expressed as ‘ua’, ‘va’ and ‘δa’, these correction amounts ‘u’, ‘v’ and ‘δ’ relative to the above deviation amounts ‘um’, ‘vm’ and ‘δm’ are expressed using the functions (u=−um), (v=−vm) and (δ=−δm). The correction amounts ua, va and δa for the target frame image Fa for the frame ‘a’ are expressed using the functions of (u=−uma), (v=−vma) and (δ=−δma). For example, the correction amounts u3, v3 and δ3 for the target frame image F3 are expressed using the functions of (u=−um3), (v=−vm3) and (δ=−δm3).

As shown in FIG. 13, by correcting the target frame image F3 using the correction amounts u3, v3 and δ3, the deviation between the target frame image F3 and the reference frame image F0 can be eliminated. Here, correction means movement of the position of each pixel of the frame image F3 by u3 in the horizontal direction, v3 in the vertical direction and δ3 in the rotational direction. When this is done, if the corrected target frame image F3 and the reference frame image F0 are displayed together on the CRT 18a, it is presumed that the target frame image F3 becomes partially aligned with the reference frame image F0, as seen in FIG. 13. In order to make the results of correction easy to understand, the hypothetical crosses X0 and X3 used in FIG. 12 are shown in FIG. 13 as well, and it can be seen in FIG. 13 that the two crosses are aligned as a result of correction.

‘Partially aligned’ as described above means that, as seen in FIG. 13, for example, the hatched area P1 is the image for an area that exists only in the target frame image F3, and an image for the corresponding area does not exist in the reference frame image F0. As a result, even where the correction described above has been performed, because an image existing only in the reference frame image F0 arises due to deviation, and conversely an image existing only in the target frame image F3 arises due to deviation, the target frame image F3 does not become completely aligned with the reference frame image F0, but becomes only partially aligned.

Similarly, by performing correction to the target frame images F1 and F2 using the correction amounts u1, v1 and δ1 and u2, v2 and δ2, respectively, the positions of each pixel of the target frame images F1 and F2 can be changed.

The correction amounts ua, va and δa for each target frame image Fa (where ‘a’ is an integer from 1 to 3) are calculated as estimated amounts by the frame image controller 110 based on the image data for the reference frame image F0 and the image data for the target frame images F1 through F3 and using a prescribed calculation formula such as the pattern matching method or the gradient method, and are transmitted to a prescribed area of the RAM 13 as translational correction amount data and rotational correction amount data.

C3. Synthesis

Following completion of correction amount estimation, synthesis processing is carried out by the still image generation unit 112. The still image generation unit 112 first performs correction to the target frame image data based on each parameter of the correction amount calculated during the correction amount estimation process (FIG. 13). The still image generation unit 112 then performs closest pixel determination.

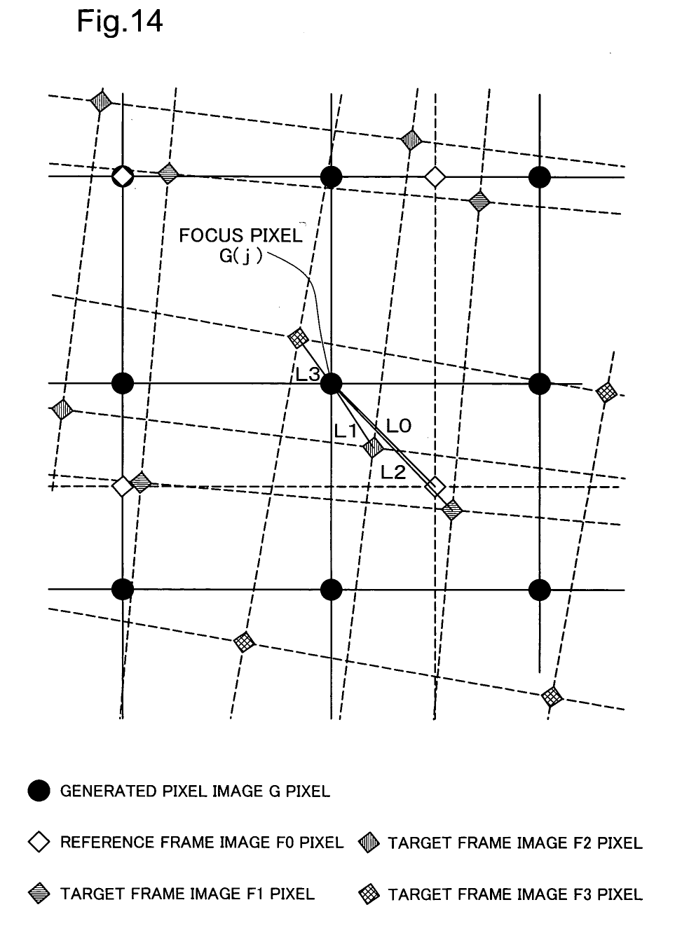

FIG. 14 is an explanatory drawing showing closest pixel determination. While the reference frame image F0 and the target frame images F1 through F3 became partially aligned as a result of target frame image correction, in FIG. 14, part of each partially aligned image is expanded so as to show the positional relationships between the pixels of the four frame images. In FIG. 14, the pixels of the enhanced high-resolution image (generated still image) G are shown as black circles, the pixels of the reference frame image F0 are shown as white diamonds, and the pixels of the corrected target frame images F1 through F3 are shown as hatched diamonds. In this embodiment, the generated still image G is resolution-enhanced such that its pixel density is 1.5 times that of the reference frame image F0. As shown in FIG. 14, the distance between pixels of the generated still image G is ⅔ of the distance between pixels of the reference frame image F0. Furthermore, the pixels of the generated still image G are positioned so as to overlap the pixels of the reference frame image F0 at every other pixel. However, the pixels of the generated still image G need not be positioned so as to overlap the pixels of the reference frame image F0. For example, it is acceptable if all of the pixels of the generated still image G are positioned at various other positions, such as between the pixels of the reference frame image F0. Furthermore, the resolution enhancement magnification is not limited to 1.5, and may be any appropriate magnification.

Here, focusing on the pixel G(j) representing the jth pixel in the generated still image G, first, the distance L0 between this pixel G(j) (termed the ‘focus pixel’ below) and the pixel belonging to the reference frame image F0 that is closest to this focus pixel G(j) is calculated. Here, because the distance between pixels of the generated still image G is ⅔ of the distance between the pixels of the reference frame image F0, the position of the focus pixel G(j) can be calculated from the position of the reference frame image F0. Therefore, the distance L0 can be calculated from the position of the reference frame image F0 and the position of the focus pixel G(j).

Next, the distance L1 between the focus pixel G(j) and the closest pixel of the target frame image F1 after correction is calculated. Because the position of the focus pixel G(j) can be calculated from the position of the reference frame image F0, as described above, and the positions of the pixels of the post-correction target frame image F1 are calculated during the correction amount estimation process described above, the distance L1 can be calculated. Similarly, the distance L2 between the focus pixel G(j) and the closest pixel of the target frame image F2 after correction and the distance L3 between the focus pixel G(j) and the closest pixel of the target frame image F3 after correction are calculated in the same way.

Next, the distances L0 through L3 are compared with one another and the pixel located the smallest distance from the focus pixel G(j) (hereinafter the ‘closest pixel’) is calculated. Because the pixel located at the distance L3 is the closest pixel to the focus pixel G(j) in this embodiment, as seen in FIG. 14, the pixel of the post-correction target frame image F3 is determined to be the closest pixel to the reference pixel G(j). Assuming that the pixel closest to the focus pixel G(j) was the ith pixel of the post-correction target frame image F3 , the pixel is referred to as closest pixel F(3,i).

The above sequence of operations is carried out for all pixels ‘j’ (j=1,2,3 . . . ) in the generated still image G, and the closest pixel to each such pixel is determined.

After performing closest pixel determination, the still image generation unit 112 performs pixel interpolation. FIG. 15 is an explanatory drawing that explains pixel interpretation using the bilinear method in this embodiment. Because gradation data does not exist for the above focus pixel G(j) prior to pixel interpolation, processing to interpolate this gradation data from the gradation data for other pixels is carried out.

The gradation data used during the interpolation process is composed of the gradation data for the three pixels of the post-correction target frame image F3 that surround the focus pixel G(j) together with the closest pixel (3,i) as well as the gradation data for the closest pixel F(3,i). In this embodiment, the gradation data for the focus pixel G(j) is sought based on the bilinear method using the gradation data for the pixel F(3,i) closest to the focus pixel G(j) and the gradation data for the pixels F(3,j), F(3,k) and F(3,1) that surround the focus pixel G(j), as shown in FIG. 15.

While a number of interpolation methods can be used other than the bilinear method, such as the bicubic method or the nearest neighbor method, an interpolation method that emphasizes the gradation data for the pixels closer to the focus pixel G(j) is preferred. Furthermore, the gradation data used for this interpolation method should include the data for the pixels that surround the focus pixel G(j) together with the closest pixel, as described above. In this way, by emphasizing the gradation data for the pixels closest to the focus pixel and carrying out interpolation using gradation data for the pixels close to the closest pixel, gradation data having a color value close to the actual color can be established.

In this way, the still image generation unit 112 performs ‘four-frame synthesis’ during still image generation processing (step S300 in FIG. 9), and generates one still image data from the four frame image data read out as described above.

Where still image data is generated during the still image generation process described above (step S300 in FIG. 9) via ‘two-frame synthesis’, the frame image controller 110 reads out into the RAM 13 from the HDD 14 the two frame image data corresponding to the paths and file names in the ‘still image 1’ and ‘still image 2’ fields in the data list (including the reference frame image data), conducts correction amount estimation processing and synthesis processing as described above, and generates one high-resolution still image data.

Where still image data is generated during the still image generation process described above (step S300 in FIG. 9) via ‘one-frame synthesis’, the frame image controller 110 reads out into the RAM 13 from the HDD 14 the reference frame image data corresponding to the path and file name in the ‘still image 1’ field in the data list, and generates one high-resolution still image data using a pixel interpolation method such as the bilinear method, the bicubic method or the nearest neighbor method.

D. Results

In this embodiment, as described above, four frame image data are acquired from the moving image data output by the digital video camera 30 or the DVD-ROM drive 15 and are stored on the HDD 14. As a result, where synthesis processing is carried out using multiple frame image data, because these multiple frame image data need not be acquired once again from moving image data output by the digital video camera 30 or the DVD-ROM drive 15, and still image data can be generated using the stored multiple frame image data, the processing time required to perform image synthesis is reduced accordingly.

In order to acquire four time-series moving image data from the moving image data output by the digital video camera 30 in sequential access format, the frame image acquisition unit 111 could repeat four times the operation of playing the moving image data and acquiring one frame image data each time. However, in this embodiment, in the sequential access mode process (FIG. 3), when frame image data is buffered in a time series in the buffer areas 301 through 304 of the buffer 140 from the moving image data playing in the preview area 210 and the user presses the frame image acquisition button 236, the buffered frame image data is acquired. As a result, because the frame image acquisition unit 111 can acquire four time-series frame images without having to repeat the operation of playing the moving image data and acquiring one frame image data four times in succession, the processing time required for generation of still image data can be reduced.

In this embodiment, when still image data is generated using a user-specified type of processing as described above (step S315 in FIG. 9), the frame image controller 110 assigns a file name to this data and stores it on the HDD 14 and enters the file name in the data list. Where the same type of processing is to be executed using the same frame images, the still image data stored on the HDD 14 is read out in accordance with the data list and is displayed in the generated still image display area 250. As a result, because the frame image controller 110 need not perform the same processing once more, the processing time can be reduced.

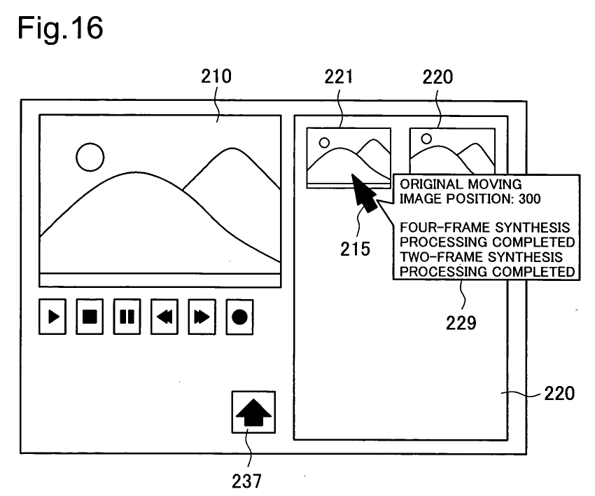

The frame image controller 110 displays the processing type number in the thumbnail image as described above. As a result, the user can learn the type of synthesis processing last performed simply by looking at the thumbnail image. The present invention is not limited to this implementation, and it is acceptable if a prescribed symbol is displayed in the thumbnail image to indicate the type of synthesis processing last performed. For example, a construction may be adopted wherein a circle is displayed if the last performed synthesis method was ‘one-frame synthesis’, a triangle is displayed if the last performed synthesis method was ‘two-frame synthesis’ and a square is displayed if the last performed synthesis method was ‘four-frame synthesis’. Alternatively, prescribed information could be displayed in the thumbnail image. Moreover, a balloon may be used as the method for displaying this prescribed information. For example, when the mouse cursor 215 is placed over the thumbnail image 221 created in the thumbnail image display area 220, a balloon containing prescribed information can be displayed, as shown in FIG. 16. The prescribed information displayed in the balloon 229 in this example includes the original moving image position and the types of [synthesis] processing performed. In this way, the user can see prescribed information such as the original moving image position or the types of processing previously performed simply by moving the mouse cursor 215 over the thumbnail image.

Because the frame image controller 110 stores the absolute frame number for the reference frame image obtained in step S125 of the sequential access mode process (FIG. 3), the search operation described below can be performed.

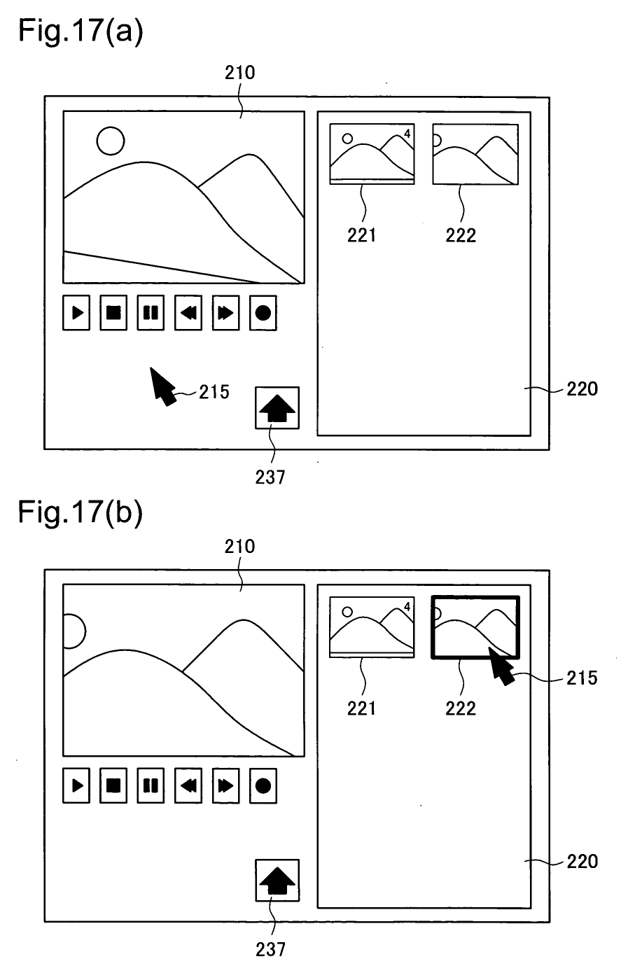

FIGS. 17(a) and 17(b) are explanatory drawings regarding a search operation using an absolute frame number in this embodiment. As shown in FIG. 17(a), thumbnail images 221 and 222 are being displayed in the thumbnail image display area 220 of the preview screen 200, and a frame image that differs from the images represented by the thumbnail images 221 and 222 is being displayed in the preview area 210.

When the user then specifies a thumbnail image for which a search is to be performed, the data list in which that thumbnail image is stored is read out and the absolute frame number for the ‘original moving image position’ in the data list is obtained. The frame image controller 110 then accesses the digital video camera 30 and rewinds or fast forwards the digital video tape (not shown) until the frame image located at the position corresponding to the obtained absolute frame number is reached. As a result, the frame image located at the position corresponding to the specified absolute frame number can be displayed in the preview area 210, as shown in FIG. 17(b). In addition, because the moving images can be played, fast forwarded or rewound from this position, frame image data located near this position can be acquired once more.

Because the frame image controller 110 stores the position information for the reference frame image obtained in step S215 in the random access mode process (FIG. 4), searching can be carried out. Specifically, when the user specifies a thumbnail image for which a search is to be performed, the frame image controller 110 reads out from the storage area 130 the data list in which the thumbnail image is stored. The frame image controller 110 then obtains the position information from the ‘original moving image position’ field of that data list. In addition, the frame image controller 110 accesses the DVD-ROM drive 15 and acquires the frame image located at the position corresponding to the obtained position information. As a result, the frame image located at the position corresponding to the position information can be displayed in the preview area 210. Furthermore, because the moving images can be played, fast forwarded or rewound from this position, the frame image data located near this position can be acquired once more.

Because the absolute frame number of the reference frame image obtained in step S125 of the sequential access mode process (FIG. 3) or the position information for the reference frame image obtained in step S215 of the random access mode process (FIG. 4) are stored, where multiple thumbnail images are being displayed in the thumbnail image display area 220, the frame image controller 110 can sort these multiple thumbnail images in a time series based on the absolute frame number or position information.

Normally, the thumbnail images displayed in the thumbnail image display area 220 are displayed in the order of their creation, and the user cannot readily determine the time-series relationships within the moving image data of the images corresponding to each thumbnail. Therefore, when the user issues an instruction to perform sorting of the thumbnail images, the frame image controller 110 reads out from the data list storage area 130 the data lists in which the thumbnail images displayed in the thumbnail display area are stored and performs sorting according to the values in the ‘original moving image position’ fields of these data lists. This enables the user to display the thumbnail images in the thumbnail image display area 220 in time-series order.

(2) Variation

The present invention is not limited to this implementation, and various other constructions within the essential scope of the invention may be employed.

In the above embodiment, the method for buffering data in the buffer 140 was the FIFO method, but the present invention is not limited to this method. For example, the buffer 140 may be a ring buffer. In this case, the frame image being played in the preview area 210 may be buffered by sequentially overwriting the buffer area of the buffer 140 in which the oldest frame image is buffered. In addition, the buffer 140 in the above embodiment may be disposed in a prescribed area of the RAM 13.

In the above embodiment, moving image data was read out from the digital video camera 30 or DVD-ROM drive 15 and multiple frame image data belonging to this moving image data were acquired and stored in the buffer 140, the RAM 13 or the HDD 14, but the present invention is not limited to this implementation. It is also acceptable if the moving image data is read out from a recording medium connected to the PC 10, such as a magneto-optical disk, CD-R/RW disk, DVD or magnetic tape, and multiple frame image data contained in this moving image data are acquired and stored in the buffer 140, RAM 13, HDD 14 or the like.

In the still image generating system of the above embodiment, the frame image data to be acquired is two or four frames of frame image data that are continuous in a time series from the time at which the instruction for acquisition is issued, but the present invention is not limited to this implementation. The frame image data to be acquired may be frame image data for three frames or for five or more frames. In this case, it is acceptable if the processing to generate relatively high-resolution still image data is performed using some or all of the acquired frame image data.

In the above embodiment, a situation was described wherein one relatively high-resolution still image data was generated by acquiring multiple frame image data that are continuous in a time series from among the moving image data, and synthesizing these frame image data, but the present invention is not limited to this implementation. It is also acceptable if one relatively high-resolution still image data is generated by acquiring multiple frame image data that are arranged but non-continuous in a time series from among the moving image data and synthesizing these frame image data. It is also acceptable to generate one relatively high-resolution still image data simply by acquiring multiple frame image data that are arranged but non-continuous in a time series from among multiple frame image data that are continuous in a time series, and synthesizing these frame image data. Such multiple image data that are continuous in a time series may comprise multiple image data captured by a digital camera via rapid shooting, for example.

In the above embodiment, a personal computer was used as the still image generating apparatus, but the present invention is not limited to this implementation. The still image generating apparatus described above may be mounted in a video camera, digital camera, printer, DVD player, video tape player, hard disk player, camera-equipped cell phone or the like. In particular, where a video camera is used as the still image generating apparatus of the present invention, one high-resolution still image data can be generated from multiple frame image data included in the moving image data for the moving images captured by the video camera at the same time as capture of moving images occurs. Furthermore, where a digital camera is used as the still image generating apparatus of the present invention, one high-resolution still image data can be generated from multiple captured image data while shooting of the photo object occurs or as the user confirms the result of image capture of the photo object.

In the above embodiment, frame image data was used as an example of relatively low-resolution image data, but the present invention is not limited to this implementation. For example, the processing described above may be carried out to field image data instead of to frame image data. Field images expressed by field image data are even-numbered and odd-numbered still images in the interlace method that comprise images equivalent to frame images in the non-interlace method.

What is claimed is:

1. A still image generating apparatus that generates still image data from multiple image data, comprising:
an image acquisition unit that obtains multiple first image data that are arranged in a time-series from the multiple image data;
an image storage unit that stores the multiple first image data obtained by the image acquisition unit;
a correction amount estimation unit that estimates with regard to the multiple first image data stored in the image storage unit, the correction amount required to correct for positional deviation among the images expressed by each image data; and
an image synthesizer that corrects the positional deviation among the images expressed by the multiple first image data based on the estimated correction amounts, and synthesizes the corrected multiple first image data to generate as the still image data second image data having a higher resolution than the first image data.

2. The still image generating apparatus according to claim 1, wherein the multiple image data include moving image data

3. The still image generating apparatus according to claim 2, wherein when an image data acquisition instruction is issued, the image acquisition unit obtains the multiple first image data from the multiple image data and the storage unit stores the obtained multiple first image data.

4. The still image generating apparatus according to claim 2, wherein the image acquisition unit sequentially obtains the first image data from the multiple image data and the image storage unit sequentially updates the stored multiple first image data with the obtained first image data, and wherein when an image data acquisition instruction is issued, the image storage unit maintains the stored multiple first image data.

5. The still image generating apparatus according to claim 1, wherein when an image data acquisition instruction is issued, the image acquisition unit obtains the multiple first image data from the multiple image data and the storage unit stores the obtained multiple first image data.

6. The still image generating apparatus according to claim 1, wherein the image acquisition unit sequentially obtains the first image data from the multiple image data and the image storage unit sequentially updates the stored multiple first image data with the obtained first image data, and wherein when an image data acquisition instruction is issued, the image storage unit maintains the stored multiple first image data.

7. The still image generating apparatus according to claim 1, wherein the image storage unit stores, in addition to the multiple first image data, the second image data generated by the image synthesizer.

8. The still image generating apparatus according to claim 7, wherein where the image synthesizer is allowed to adopt one of multiple image synthesis methods selectively when synthesizing the corrected multiple first image data to generate the second image data, the image storage unit stores the second image data synthesized using different synthesis methods separately according to the synthesis method employed.

9. The still image generating apparatus according to claim 8, wherein when an instruction is issued for re-synthesizing the corrected multiple first image data using the same synthesis method that was previously used on the data, the image synthesizer reads out the second data that was already synthesized using that method from the image storage unit rather than performing synthesis to the corrected multiple first image data.

10. The still image generating apparatus according to claim 1, wherein the image storage unit stores, in addition to the multiple first image data, position information indicating the time location in the multiple image data for at least one of the obtained multiple first image data.

11. The still image generating apparatus according to claim 1, further comprising:
a thumbnail image creation unit that creates thumbnail image data from the second image data generated by the image synthesizer; and
an image display unit that displays at least the thumbnail image expressed by this thumbnail data,
wherein the image display unit displays the thumbnail image together with predetermined information concerning the second image data corresponding to the thumbnail image.

12. The still image generating apparatus according to claim 11, wherein where the image synthesizer is allowed to adopt one of multiple image synthesis methods selectively when synthesizing the corrected multiple first image data to generate the second image data, the predetermined information is information that indicates the synthesis method employed when the second image data corresponding to the thumbnail image data was generated.

13. A still image generating method of generating still image data from multiple image data, the method comprising the steps of:
(a) obtaining multiple first image data that are arranged in a time-series from the multiple image data;
(b) storing the obtained multiple first image data in memory;
(c) estimating from the stored multiple first image data the correction amount required to correct for positional deviation among images expressed by each image data; and
(d) correcting the positional deviation among the images expressed by the multiple first image data based on the estimated correction amounts, and synthesizing the corrected multiple first image data to generate as the still image data second image data having a higher resolution than the first image data.

14. A computer-readable recording medium on which is recorded a computer program that generates still image data from multiple image data, wherein the computer program executes on the computer the functions of:
obtaining multiple first image data that are arranged in a time-series from the multiple image data;
storing the obtained multiple first image data in memory;
estimating from the stored multiple first image data the correction amount required to correct for positional deviation among images expressed by each image data; and
correcting positional deviation among the images expressed by the multiple first image data based on the estimated correction amounts and synthesizing the corrected multiple first image data to generate as the still image data second image data having a higher resolution than the first image data.
